(19) United States
(12) Patent Application Publication
(10) Pub. No.: US 2007/0256314 A1
(43) Pub. Date: Nov. 8, 2007

(54) Measured steel fish tape

(76) Inventor: Rodolfo Ruiz, El Paso, TX (US)

Correspondence Address: Rodolfo Ruiz, 7322 Mojave, El Paso, TX, 79915, US

(21) Appl. No.: 11/418,535

(22) Filed: May 5, 2006

(51) Int. Cl. G01B 3/10

(52) U.S. Cl. 33/759

(57) ABSTRACT

A steel fish tape that is functional and time- and money-saving. The original wide, flat form of the fish tape allows for imprinted measurements, thereby enabling the measurement imprints to start at one (1) inch and reach up to the length of the fish tape including every inch in between each foot.

### FIELD OF THE INVENTION

The present invention relates to steel fish tapes and, more particularly, to a steel fish tape that is able to measure the amount of electrical wire needed.

### BACKGROUND OF THE INVENTION

As the price of wire continues to rise, companies try to save money and time by attempting to find ways to correctly measure wire, but instead find themselves wasting wire and time due to incorrect forms of measuring.

Initially, fish tape was used to pull wire from pipes. Currently, the fish tape is also marked, for the length of wire needed, while in the pipe then pulled out of the pipe and measured with a measuring tape in order to obtain an accurate length of wire needed.

Prior fish tapes are not equipped with any form of imprinted measurements in order to obtain the adequate amount of wire needed in less time.

It is therefore an object of the invention to provide a steel fish tape with imprinted measurements.

It is another object of the invention to provide accurate measurements in order to obtain correct length of wire required.

It is another object of the invention to be able to obtain accurate measurement from steel fish tape while being uncoiled.

It is another object of the invention to be able to obtain the desired measurements at the designated points.

### SUMMARY OF THE INVENTION

In accordance with the present invention, there is provided a steel fish tape that is functional and time- and money-saving. The original wide, flat form of the fish tape allows for imprinted measurements, thereby enabling the measurement imprints to start at one (1) inch and reach up to the length of the fish tape including every inch in between each foot.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a right view of a steel fish tape;

FIG. 2 is a detail view of a hook on the steel fish tape;

FIG. 3 is a detail view of a measurement imprints on steel fish tape starting at one (1) inch; and

FIG. 4 is a detail view of a measurement imprints on steel fish tape continuing the markings of each inch after every foot.

For purposes of clarity and brevity, like elements and components will bear the same designations and numbering throughout the Figures.

### DESCRIPTION OF THE PREFERRED EMBODIMENT

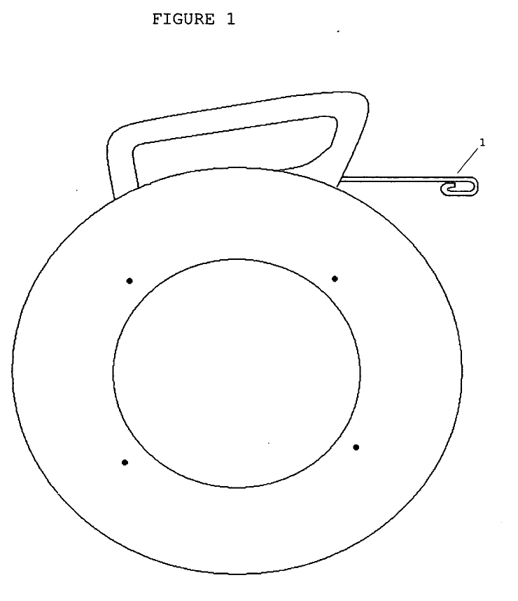

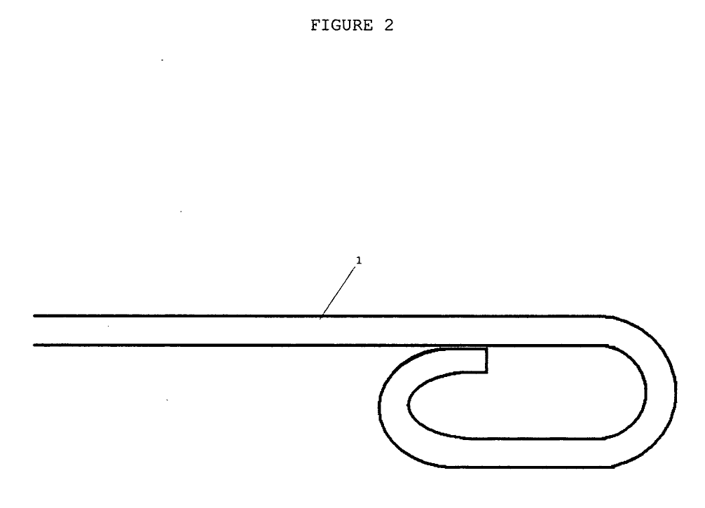

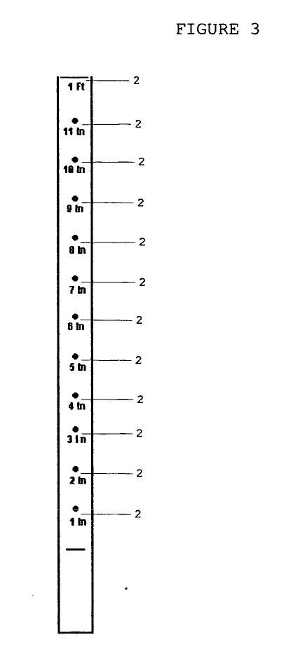

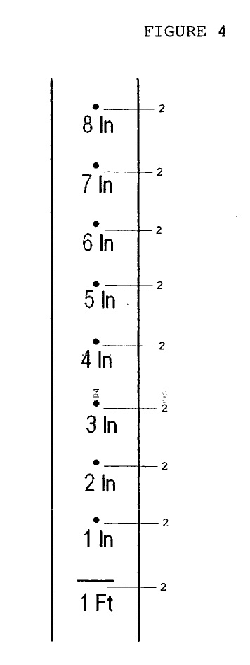

FIG. 1 is a right view of a steel fish tape. This is the basic look of the outer casing of all fish tapes. FIG. 2 is a detail view of a hook with measurements 1 on the steel fish tape. These measurement imprints begin where the hook ends. FIG. 3 is a detail view of a measurement imprint 2 on steel fish tape starting at one (1) inch. Each measurement imprint 2 is made at exactly every inch and foot and is continued throughout the length of the steel fish tape. FIG. 4 is a detail view of a measurement imprint 2 on steel fish tape continuing the measurement imprint 2 of each inch between every foot. Each measurement imprint 2 is also made with not only a slash or dot, but also a number and in. for inches or ft. for foot or feet. The measurement imprints on the steel fish tape facilitate the process of measuring the desired amount of wire.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A measured steel fish tape for determining amount of electrical wire needed, comprising:
means for pulling wire and measuring amount of wire at the same time; and
means for accuracy in obtaining the amount of wire desired, equidistantly embedded to said means for pulling wire and measuring amount of wire at the same time.

2. The measured steel fish tape in accordance with claim 1, wherein said means for pulling wire and measuring amount of wire at the same time comprises a hook with measurements.

3. The measured steel fish tape in accordance with claim 1, wherein said means for accuracy in obtaining the amount of wire desired comprises a measurement imprint.

4. A measured steel fish tape for determining amount of electrical wire needed, comprising:
a hook with measurements, for pulling wire and measuring amount of wire at the same time; and
a measurement imprint, for accuracy in obtaining the amount of wire desired, equidistantly embedded to said hook with measurements.

5. A measured steel fish tape for determining amount of electrical wire needed, comprising:
a hook with measurements, for pulling wire and measuring amount of wire at the same time; and
a measurement imprint, for accuracy in obtaining the amount of wire desired, equidistantly embedded to said hook with measurements.
